(19) United States
(12) Patent Application Publication
(10) Pub. No.: US 2003/0036936 A1
(43) Pub. Date: Feb. 20, 2003

(54) Computer method and apparatus to estimate customer arrival times using transactional data

(76) Inventors: Jennifer L. Steichen, Crofon-on-Hudson, NY (US); Ying Tar Leung, Tarrytown, NY (US)

Correspondence Address: McGuire Woods LLP, Suite 1800, 1750 Tysons Boulevard, McLean, VA, 22102-3915, US

(21) Appl. No.: 09/931,108

(22) Filed: Aug. 17, 2001

(51) Int. Cl. G06F 17/60

(52) U.S. Cl. 705/7

(57) ABSTRACT

A method implemented on a computer based system which receives transaction data from terminals and estimates customer arrival times and dynamic queue lengths at the terminals by extracting service time data from the point-of-sale terminals and then grouping customers into busy periods. Based on this information, the method estimates customer arrival times for each busy period. These arrival times may be used to construct a queue length for each busy period, and to calculate queue performance measures based on the constructed queue lengths.

### BACKGROUND OF THE INVENTION

1. Field of the Invention

The present invention generally relates to a method of estimating customer arrival times at a terminal (e.g., a cash register) using transactional data from the terminal. The present invention may be implemented to estimate queue length at checkout lanes in a retail establishment, in a bank, at customer service desks, at self-service kiosks, at banks, or any other location where a queue (line) of people or other objects may form.

2. Background Description

Many different businesses involve customers in a queue at a terminal. The terminal may be a point-of-sale terminal, an ATM machine, or any kind of machine that records service time data. In the retail business, each retail store often has several point-of-sale (POS) terminals (e.g., cash registers). Retail store managers attempt to strategically schedule the operation of these point-of-sale terminals. On the one hand, the store managers would like to maintain reasonable customer service by preventing long lines of customers. On the other hand, they must consider personnel constraints. For example, it may be more efficient for some employees to stock shelves or attend to other store activities. To have a sound strategy for operating point-of-sale terminals, managers must have some understanding of how busy the point-of-sale terminals are at different times of day.

In order to aid these retail managers in developing such an understanding, we estimate point-of-sale customer arrival times using the transactional data collected by each cash register. These arrival time estimates can then be used to estimate queue length. This queue length estimate can be used to estimate performance measures for the actual queue length such as average queue length, proportion of time that the queue length is above a certain value, and the number of times the queue length crosses a certain threshold. Commercially available point-of-sale terminals collect the transaction data that is used to calculate this queue estimate.

The general problem of estimating customer arrival times from transaction data has not been considered by others. For our discussion, we define customer as a person, group of people, object, or group of objects that eventually results in one transaction. The general problem of estimating the queue length at a terminal has been considered by a number of people. There are two main methods conventionally recognized: video methods and one software method. Video methods include those patented by Huang and Florencio of NCR Corporation in U.S. Pat. Nos. 5,953,055 and 6,195,121, both entitled “System and method for detecting and analyzing a queue.” The conventional software method of estimating the expected queue length is first proposed by Richard C. Larson in “The Queue Inference Engine: Deducing Queue Statistics from Transactional Data”, Management Science, 36, no. 5, pp. 586-601 (1990), and extended by Dimitris J. Bertsimas and L. D. Servi in “Deducing queueing from transactional data: the queue inference engine, revisited”, Operations Research, 40, suppl. 2, S217-S228 (1992) and by Richard C. Larson in “The Queue Inference Engine: Addendum,” Management Science, 37, No. 8, pp 1062, (1991).

Video methods have the advantage of observing the queue in real-time, but there are many drawbacks to such methods. These drawbacks include cost of camera, cost of extra computers for processing the camera images, difficulty in differentiating buying units, and difficulty of installation of the system.

The conventional software method of estimating queue length by calculating the conditional expectation of the queue length is similar to the proposed method. Benchmarking studies have showed that the proposed method of using estimated customer arrival times is faster, has less storage problems, and predicts some dynamic measures of queue length better than using the conditional expectation.

A solution to the problem of estimating queue length from transactional data in a way that is stable, robust, fast, and good at predicting the dynamics of the queue length is needed. Estimating customer arrival times and the constructing the queue length from these arrival estimates can produce such a queue length estimate.

### SUMMARY OF THE INVENTION

It is therefore an object of the present invention to provide a means of estimating customer arrival times from transactional data in a way that can be used to estimate queue length.

According to the invention, there is provided a method and apparatus which estimates customer arrival times and the number of transactions in line at different times using transactional data to generate a dynamic queue length estimate. The transaction arrival process is unknown and assumed to be random. This transactional data is used to produce an estimate of the start and end of service of each customer. Using these service time estimates, the customers are grouped into busy periods. Each busy period represents time when there are transactions continually in service or waiting in line. Between each busy period is an idle period during which no transactions are in service or waiting in line at that particular POS register. For each busy period, we already have estimates of the service start and end times. We then estimate the arrival times, and use these to construct the estimate of the queue length. Various measures of the actual queue length process can be estimated by the same measures of the estimated queue length process.

The method according to the invention is implemented on a computer based point of sale terminal and estimates dynamic queue lengths at the point of sale terminal by extracting service time data from the terminal and then grouping customers into busy periods. Based on this information, the method estimates arrivals for each busy period from these estimated arrival times, constructs a queue length for each busy period, and calculates queue performance measures based on the constructed queue lengths.

The main difference between this invention and existing software algorithms is that the present invention estimates the arrival times of customers and then constructs the queue length rather than constructing a non-integer valued time estimate of queue length.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block diagram showing the hardware and the communications needed between the hardware for the invention;

FIG. 2 is a block diagram showing the different components of the point-of-sale queue estimator program;

FIG. 3 is a block diagram showing an example of data available from a point-of-sale terminal for one transaction;

FIG. 4 is a time line showing grouping of customers into busy periods separated by idle periods;

FIG. 5 is a time line illustrating an example of the construction of the queue length estimate during a busy period;

FIG. 6 is a block diagram showing the data flow from a POS terminal to the POS Server which generates a queue report; and

FIGS. 7A, 7B, 7C and 7D, taken together, are a flow diagram of the process implemented according to the invention.

### DETAILED DESCRIPTION OF A PREFERRED EMBODIMENT OF THE INVENTION

A method and apparatus are described for estimating customer arrival times and estimating the queue length at a terminal using this estimate of arrival times. In the following description, for the purpose of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention includes various steps, which are described below. The steps can be embodied in machine-executable instructions, which can be used to cause a general-purpose or special-purpose processor programmed with the instructions to perform the steps. Alternatively, the steps of the present invention might be performed by specific hardware components that contain hardwired logic for performing the steps, or by any combination of programmed computer components and custom hardware components.

### System Overview

The present invention may be included in a system for estimating performance measures of a queue at a point-of-sale (POS) terminal. Referring now to the drawings, and more particularly to FIG. 1, there is shown a block diagram of the hardware and the communications between hardware assumed for the point-of-sale queue estimator. A number of point-of-sale (POS) terminals 12₁, 12₂, 12₃, and 12₄ collect transaction data and send this data to the point-of-sale server 10. This server 10 may actually be one of the point-of-sale terminals 12₁. The data from the point-of-sale server 10 is copied to an application computer 11. According to the present invention, the queue estimator program is run on this application computer 11. The application computer 11 may be the same as the point-of-sale server 10, but they are shown in the figure as separate entities to differentiate their functions.

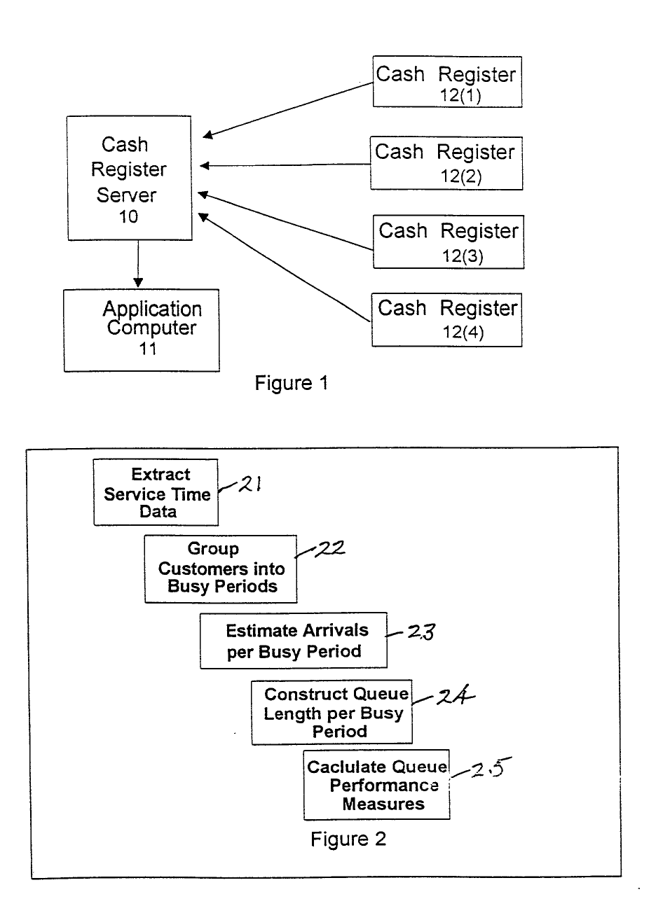

FIG. 2 illustrates the steps of our embodiment of this invention. The first step 21 is to extract the service time data. Customers are then grouped into busy periods in step 22. Based on the extracted data in step 21 and the grouping of customers in step 22, the arrival times per busy period are estimated in step 23. These estimates are used in step 24 to construct a queue length for each busy period. Finally, in step 25 queue performance measures are calculated from the queue length.

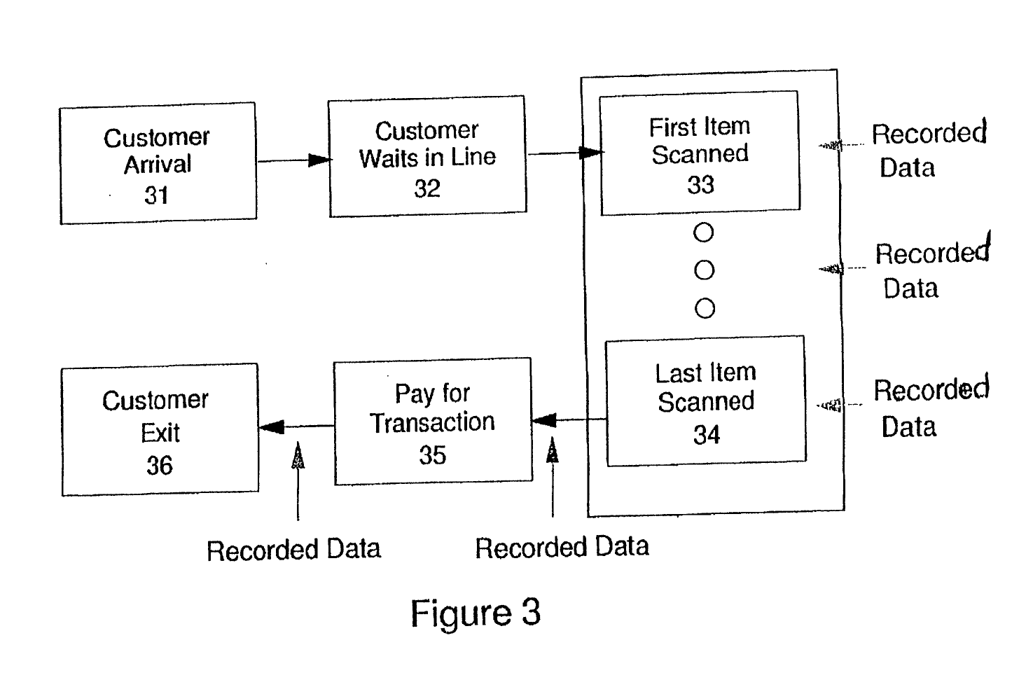

FIG. 3 illustrates an example of data available from a POS terminal for a transaction. In the transactional process, the customer arrives at 31 and waits in line at 32. The POS terminal 12 either manually or automatically (or semi-automatically) scans (or otherwise records) a series of items the customer is purchasing (or actions that the customer is performing), beginning with a first item at 33 and finishing with a last item at 34. After the last item has been scanned, the total charge for all items, plus tax (if any), is displayed by the POS terminal 12, and the customer pays for the transaction at 35. After payment is made, the customer exits at 36.

The actual arrival time of each customer (except possibly the first customer for each busy period) is not collected nor is the time that the customer waits in line. Usually, the POS terminal 12 collects data on each item that is scanned or otherwise recorded including the time that the item is recorded. The terminal 12 may record the time right before the transaction is paid for, but the terminal does not usually record any time after the transaction is paid for. The terminal does record the time that payment is received. The time stamps at the beginning arrow and ending arrow are the estimated service start and end times, respectively.

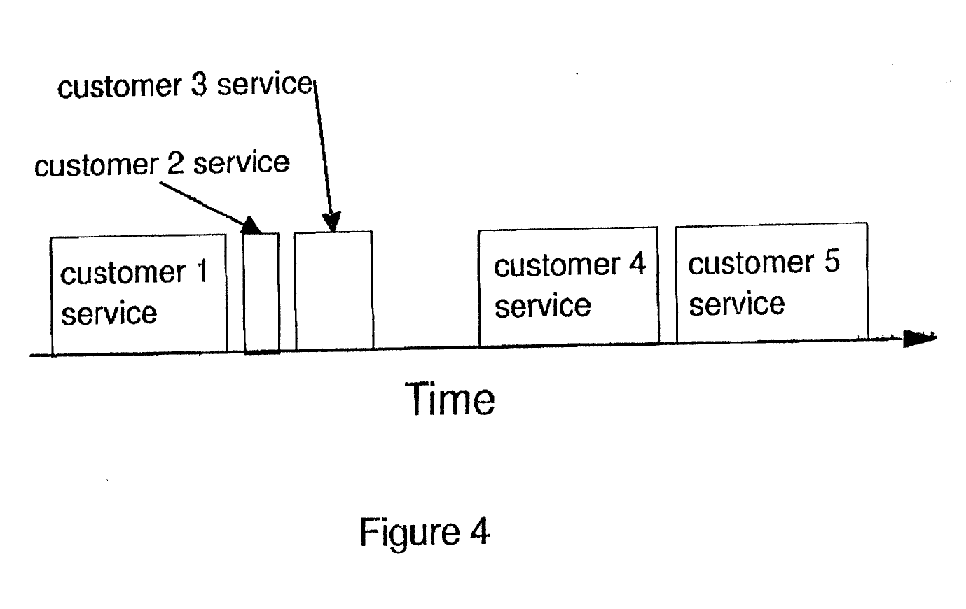

FIG. 4 illustrates an example of grouping customers into busy periods. In this figure, one sees the duration of the estimated service times of five customers. Since the end of customer 1 service is close to the start of customer 2 service, these two customers are grouped into the same busy period. By the same reasoning, customer 3 is also grouped into the same busy period. But, the end of service of customer 3 is much before the start of service of customer 4. So, one busy period will consist of customers 1, 2 and 3. This busy period is followed by an idle period for the terminal, and the next busy period will include customers 4 and 5.

For each busy period, the first arrival occurs at the beginning of the busy period. If there is a second arrival during this busy period, then the second arrival arrives after the first arrival but before the start of the second service. In general, the nth arrival during a busy period occurs after the (n−1)th arrival and before the start of the nth service during that busy period. The arrival times can be estimated by assuming a certain distribution of an arrival time given the constraints just mentioned. For example, the second arrival could be estimated as the midpoint of the interval between the first arrival and the start of the second service or it could be estimated in a way that depends on the length of the busy period.

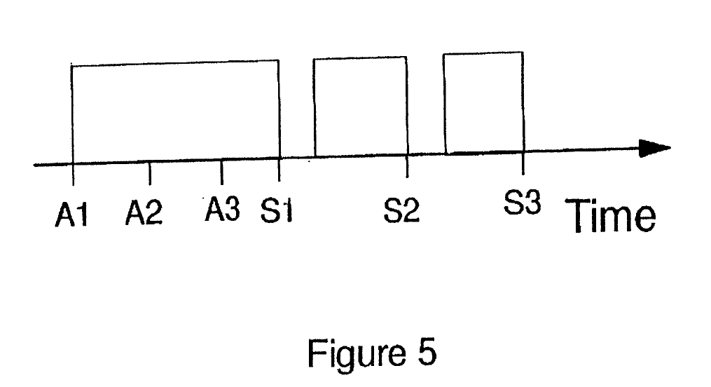

FIG. 5 gives an example of queue length construction from the service times and the arrival times. In this example, there are three customers during the busy period with arrival times A(1), A(2) and A(3) and service ending times S(1), S(2) and S(3). The queue length jumps up by one at all arrivals times, jumps down by one at all service times, and stays constant at all other times.

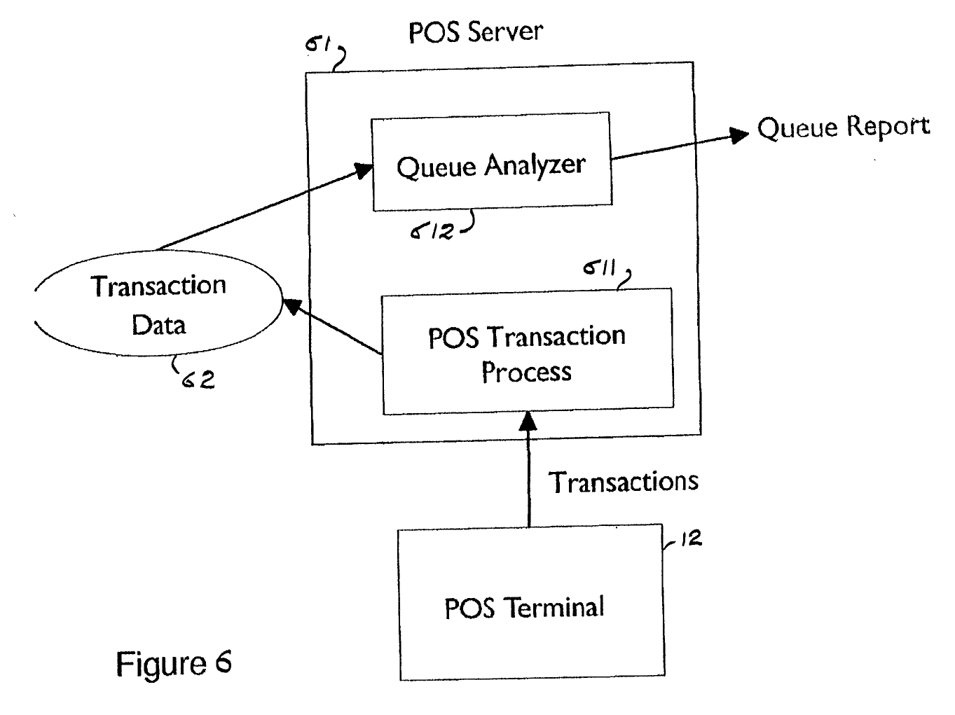

FIG. 6 is a simplified block diagram showing the data flow in processing the transactional data. A single POS terminal 12, is shown representing all the POS terminals in a store. In FIG. 6, the server 10 and the computer 11 are combined into a single POS server 61. During the course of the day, the POS server 61 receives transaction data from each of the POS terminals under the control of a transaction process module 611. This transaction data is stored in a storage device 62. At a requested time, a queue analyzer module 612 retrieves the stored transaction data from the storage device 62 and generates a queue report.

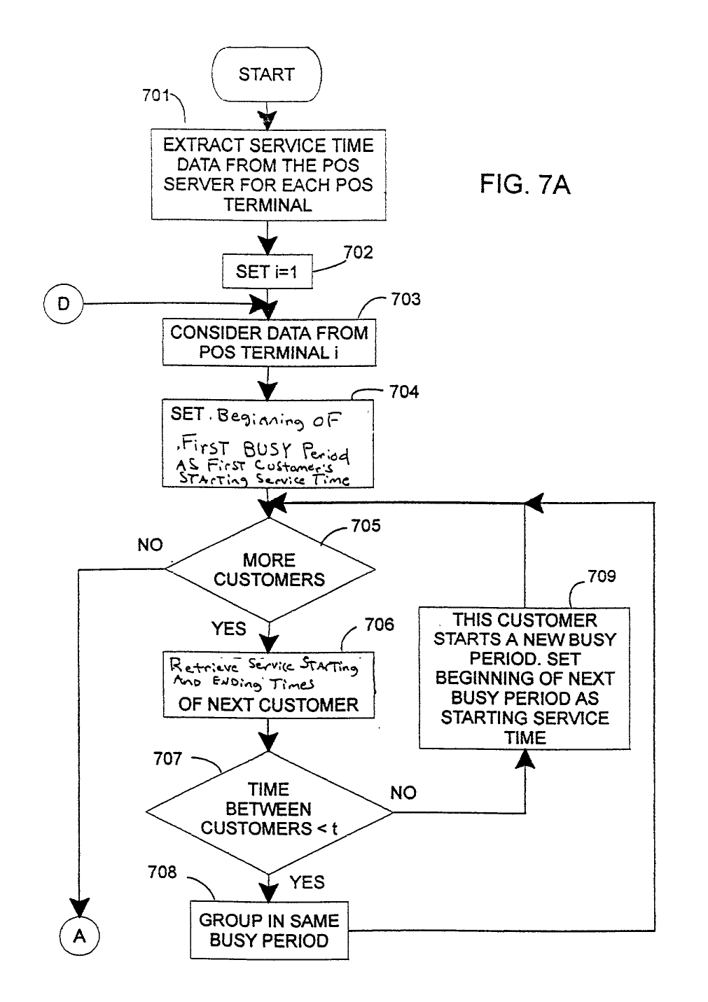

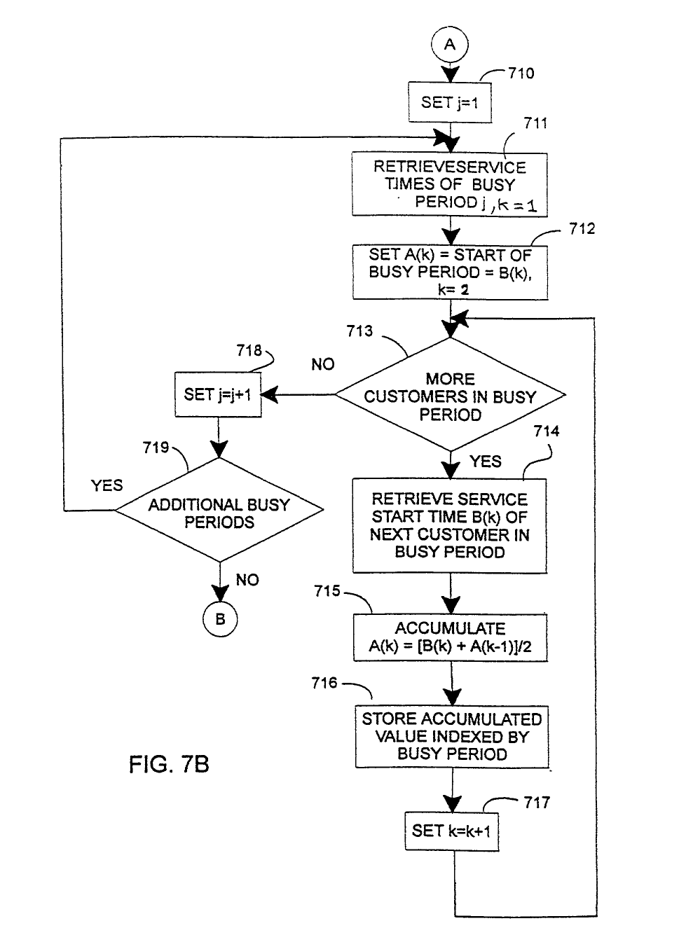

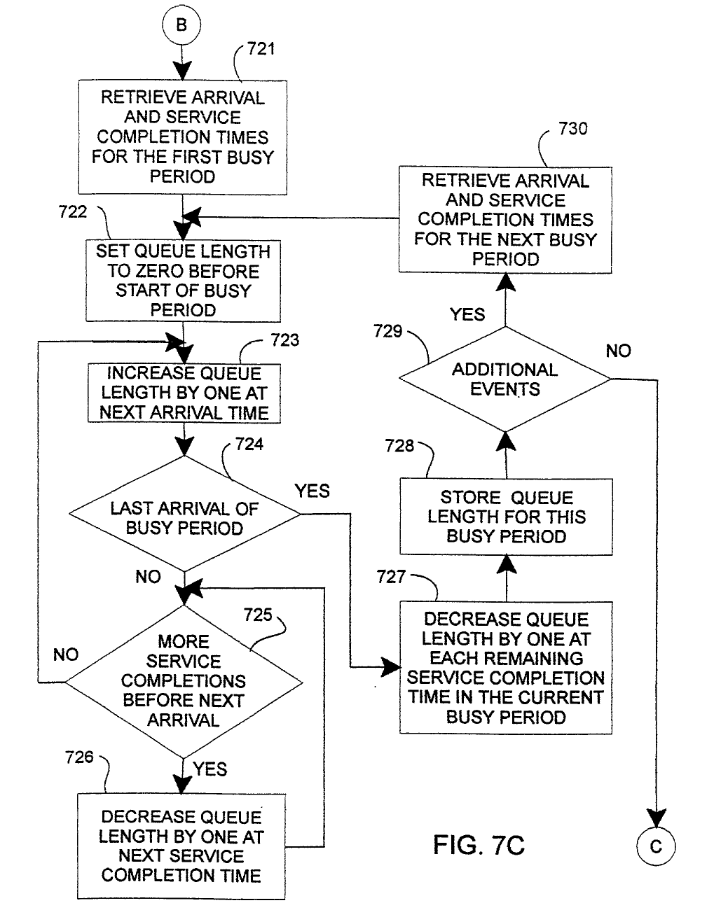

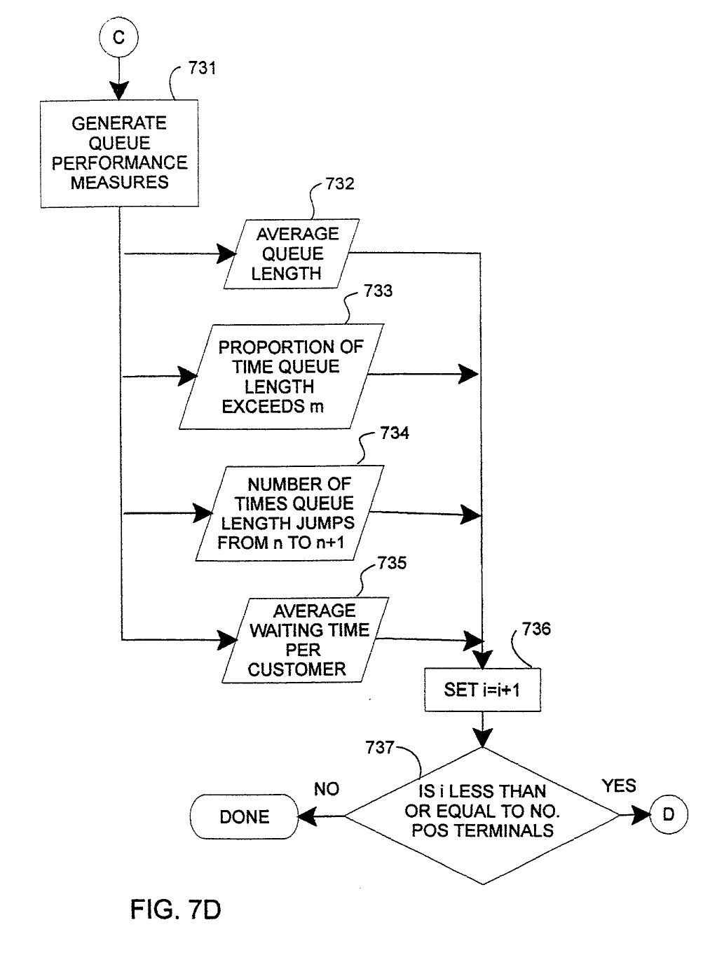

FIGS. 7A, 7B, 7C and 7D, taken together, are a flow diagram of the overall process performed by the POS server 61 (FIG. 6). The process starts in FIG. 7A by extracting service time data from the POS server 61 in function block 701. An index i is set to 1 in function block 702 before a processing loop is entered. The index i corresponds to POS terminals, i=1, . . . , n, where n is the number of POS terminals. The processing loop is entered at function block 703 where the data from POS terminal i is considered. In function block 704, the first busy period starts at the first service starting time. Then, a nested processing loop is entered at decision block 705 where a test is made to determine if there are more customers. If so, the starting and ending times of the next customer are retrieved in function block 706.

A determination is made in decision block 707 as to whether the time between customers, that is the ending service time of the preceding customer and the starting service time of this customer is less than a threshold time, t, indicating that this customer had been part of the queue for this POS terminal for this busy period. If the time between customers is less than t, then this customer is grouped in the same busy period as the preceding customer, and the process loops back to decision block 705. If the time between customers is greater than the threshold time, then this customer is not grouped in the same busy period as the preceding customer. Instead, this customer starts a new busy period. The beginning of this new busy period is set as the start of service time for this customer in function block 709. When all customers for this POS terminal for the requested time period have been processed and grouped, as determined by decision block 705, the process exits this busy loop at connector A and goes to FIG. 7B.

In FIG. 7B, a second nested processing loop is then entered at function block 710 where an index j is set to 1 and the index k is set to 1. The service times for busy period j for this POS terminal are retrieved in function block 711. In function block 712, A(k) is set to the start of the busy period which is equal to B(k), the service start time of the next customer. The index k is set to 2. A test is made in decision block 713 to determine if there are more customers in the busy period being processed. If so, the process goes to function block 714 where the service start time B(k) of the next customer in the busy period is retrieved. An accumulation function is performed in function block 715, and the accumulated value is stored, indexed by busy period, in function block 716. This accumulation step is not a unique formula;

there are many other expressions for A(k) that will suffice, such as A(k)=A(k−1)+(A(k−1)+B(k))/(1+n/5) where n is the length of the busy period. The process then loops back to decision block 713. When all of the customers in the current busy period have been processed as determined in decision block 713, the index j is incremented by one in function block 718, and a test is made in decision block 719 to determine if there are additional busy periods to be processed. If so, the process goes to function block 711 where the next busy period is retrieved. When all busy periods have been processed for this POS terminal as determined by decision block 719, this nested processing loop exits at connector B.

The process then goes to function block 721 in FIG. 7C where the arrival and service completion times for the first busy period are retrieved. The queue length is set to zero before the first busy period in function block 722. The queue length is increased by one at the next arrival time in function block 723. A test is then made in decision block 724 to determine if this is the last arrival of the busy period. If not, a further test is made in decision block 725 to determine whether there are more service completions before the next arrival. If not, the process loops back to function block 723; otherwise, the queue length is decreased by one at the next completion time. Then the process loops back to decision block 725. When the last arrival of the busy period is detected in decision block 724, the queue length is decreased by one at each remaining service completion time in the current busy period in function block 727. The queue length for the busy period is stored in function block 728, and a test is made in decision block 729 to determine if there are additional events to be processed. If so, the arrival and service completion times for the next busy period are retrieved in function block 730. When there are no further events to be processed as determined in decision block 729, this processing loop exits at connector C.

The process then goes to function block 731 in FIG. 7D where queue performance measures are generated. These performance measures include an average queue length at output block 732, the proportion of time the queue length exceeds a predetermined threshold value, m, at output block 733, the number of times the queue length jumps from a predetermined value n to n+1 at output block 734, and the average waiting time per customer at output block 735. These performance measures may be displayed and/or printed out for review by the manager of the store. The index I is then incremented by one in function block 736, and a test is made in decision block 737 as to whether the index I less than or equal to the number of POS terminals. If so, the process loops back, via connector D, to function block 703 in FIG. 7A to process the data for the next POS terminal.

With these queue performance measures, a manager of a store can better allocate personnel so as to provide improved service to customers. In addition, the performance measures may be used by regional managers to determine the relative performances of branch stores.

The invention has particular application in retail establishments having multiple POS terminals to which various clerks may be assigned, additional POS terminals being opened as busy periods demand. However, the invention has application to fully automated terminals for both retail sales and other applications including, for example, automated teller machines (ATMs). Thus, while the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A method of estimating customer arrival times at a terminal, comprising the steps of:
extracting service time data from the terminal;
grouping customers into busy periods; and
estimating customer arrival times for each busy period based on said extracted service time.

2. The method of claim 1, further comprising:
constructing a queue length for each busy period; and
calculating queue performance measures based on the constructed queue lengths.

3. The method of claim 1, further comprising:
outputting the calculated performance measures for analysis.

4. The method of claim 1, wherein the terminal is a point-of-sale (POS) terminal.

5. The method of claim 4, wherein there are a plurality of POS terminals and the method is performed for each of the plurality of POS terminals to generate queue performance measures for each of said POS terminals.

6. The method of claim 5, further comprising the step of outputting the generated performance measures for each POS terminal for analysis.

7. An apparatus for estimating dynamic queue lengths of customers at a terminal comprising:
extraction means for extracting service time data from the terminal;
a storage device for storing extracted service time data; and
a processor retrieving stored data from the storage device and grouping customers into busy periods, estimating customer arrivals for each busy period, constructing a queue length for each busy period, and calculating queue performance measures based on the constructed queue lengths.

8. The apparatus of claim 7, further comprising:
output means for outputting the calculated queue performance measures for analysis.

9. The apparatus of claim 7, wherein the terminal is a point-of-sale (POS) terminal.

10. The apparatus of claim 9, wherein there are a plurality of POS terminals, said extracting means extracting data from each of the plurality of POS terminals and storing the data in the storage device, and the processor retrieving and separately processing the data for each POS terminal stored in the storage device to generate queue performance measures for each of said POS terminals.

11. The apparatus of claim 10, further comprising:
output means for outputting the generated queue performance measures for analysis.
